(19) United States
(12) Patent Application Publication
(10) Pub. No.: US 2002/0047756 A1
(43) Pub. Date: Apr. 25, 2002

(54) Multi-coupler

(76) Inventors: Rafi Hershtig, Salisbury, MD (US); Ray Delario, Salisbury, MD (US); Randy W. Hammer, Bishopville, MD (US); David L. Spann, Salisbury, MD (US)

Correspondence Address: BANNER & WITCOFF, 1001 G STREET N W, SUITE 1100, WASHINGTON, DC, 20001, US

(21) Appl. No.: 09/774,793

(22) Filed: Feb. 1, 2001

Related U.S. Application Data
(63) Continuation of application No. 09/291,759, filed on Apr. 14, 1999.
(60) Provisional application No. 60/081,647, filed on Apr. 14, 1998.

(51) Int. Cl. H01P 1/213

(52) U.S. Cl. 333/134; 333/202

(57) ABSTRACT

A new coaxial multi-coupler that is relatively inexpensive and efficient to manufacture in a low volume and high product mix manufacturing environment. A plurality of coaxial resonators are bonded together to form the multi-coupler. Then, at least one coupling hole is formed for capacitively and/or inductively coupling at least two of the resonators together. Formation of coupling holes upon bonding the resonators together allows for improved manufacturing techniques, convenient fine-tuning of coupling between resonators, and significantly better overall filter/multi-coupler performance as compared with the prior art. One reason for this is that precise alignment of the resonators during bonding is unnecessary according to aspects of the present invention.

The present application claims priority under 35 U.S.C. §119(e) to copending U.S. Provisional Patent Application Ser. No. 60/081,647, entitled “Multi-Coupler,” and filed on Apr. 14, 1998.

### FIELD OF THE INVENTION

The present invention is directed generally to multi-couplers, and specifically to coaxial resonator multi-couplers and methods of manufacture thereof.

### BACKGROUND

Referring to FIG. 1, a conventional coaxial resonator filter 100 has a plurality of ceramic coaxial resonators 102a, 102b, 102c. Each of the resonators has a resonator hole 103a, 103b, 103c coated with metal (i.e., metallized). Each of the resonators 102a-c is metallized on all exterior surfaces except for their top surfaces 107a, 107b, 107c. To create the filter 100, the coaxial resonators 102a-c are connected together at their exterior metallic surfaces as shown in FIG. 1. The metallized surfaces of the resonators are grounded, effectively forming ground planes 108, 109 between each of the individual coaxial resonators. Prior to bonding the resonators together, coupling windows 104a, 104b are machined or etched in each of the resonators. Once the resonators are connected together, the coupling windows 104a-b serve to electromagnetically couple adjacent resonators together. Thus, for example, coupling window 104a couples resonator 102a with resonator 102b, and coupling window 104b couples resonator 102b with resonator 102c. Finally, terminal electrodes 105a, 105b are attached to the filter 100 and wires 106a, 106b are attached to the terminal electrodes.

To manufacture a conventional filter, a single resonator is taken out of a bin, a first coupling window is machined in one side of the resonator, the resonator is inverted, another coupling window is machined in the other side of the resonator (possibly having a different size), and the resonator is placed back in the bin. This process is repeated for each of a plurality of different resonators, each resonator having various combinations of coupling window sizes and locations. After forming all of the coupling windows, the resonators are assembled into a filter having, for example, five resonators. During reassembly, the resonators must be exactly positioned such that each of the coupling windows of adjacent resonators are exactly aligned. Then the plurality of resonators are soldered together to form a single filter.

A problem with the above manufacturing process is that it is extremely difficult and work-intensive to precisely align the windows of adjacent coaxial resonators such that the desired filtering effects are obtained. The windows must be aligned with an accuracy of at least the size of the windows. The problem of misalignment is further magnified where the windows 104a-b are extremely small (e.g., 2/1000ths of an inch) and where manufacturing tolerances are not negligible. A substantial amount of manual re-working of the resonators is often required. In many cases, misalignment of the coaxial resonators 102a-c degrades filter performance, and even limits the tolerances that may be practically achieved on a conventional manufacturing line. For example, it is often difficult to achieve greater than a 3% bandwidth (defined as the percentage ratio of the bandwidth measured between the two −3 dB points, divided by the center frequency of the filter) in a conventional resonator filter. Forming filters from individual coaxial resonators using conventional methods is therefore problematic.

The monoblock filter has also been tried. A monoblock 200, which is made from a single piece of ceramic, is shown in FIG. 2. The monoblock 200 has a plurality of metal-plated coupling holes 201 that act as resonators, and a plurality of non metal-plated coupling holes 202. The monoblock 200 further has a metal outer wall forming the ground and surrounding all of the ceramic resonators 201 except the top surface. A difference between the monoblock configuration and the configuration described above using a plurality of individual coaxial resonators is that the monoblock 200 provides no ground planes within the ceramic between the holes 201. The monoblock 200 is not suitable for an environment that requires substantial customization during the manufacturing process, such as where a low volume and a high product mix is desirable. Furthermore, the tooling required for manufacturing the monoblock is substantially more expensive than that required where the resonators are formed individually and then coupled together. Accordingly, a better solution is required.

Referring to FIG. 3, a third conventional resonator arrangement is the use of a coupling board 300. The coupling board 300 typically has a plurality of metal surfaces 302, 303 on each side of a dielectric sheet 301. On one side of the dielectric sheet 301, the metallic surfaces 303 are connected with the metal coating on the interior surfaces of respective coaxial resonators. The metal surfaces on both sides of the dielectric sheet 301 are positioned such that capacitive and/or inductive coupling is created between coaxial resonators. FIG. 4 illustrates an equivalent circuit 400 of the coaxial resonators 2a-c and the coupling board 300 shown in FIG. 3. Capacitors C₁ and C₂ represent, respectively, the capacitances between the terminal electrodes 105a and 105b and the resonator holes 103a and 103c. Parallel inductor/capacitor pairs (L₁ and C₃), (L₂ and C₄), and L₃ and C₅) represent the unloaded resonators 102a-c, respectively. Capacitors C₆ and C₇ represent the coupling capacitance, respectively, between the resonator pairs (102a and 102b) and (102b and 102c). The coupling capacitance could alternatively be a coupling inductance. Finally, capacitors C₈ and C₉ represent, respectively, the capacitance derived from the coupling board 300 between the resonator pairs (102a and 102b) and (102b and 102c). The capacitance and/or inductance provided by the coupling board may be adjusted by varying the size and/or relative position of the metallic surfaces 302, 303. Thus, the coupling board 300 may be used to form a filter having different characteristics. However, to be effective, each coupling board 300 must be custom-tailored to the individual filter configuration. Thus, the coupling board solution is also inefficient in a low volume and high product mix manufacturing environment since a different coupling board is required for each custom filter. Accordingly, the coupling board also has disadvantages in certain applications.

### SUMMARY OF THE INVENTION

One or more aspects of the present invention solve one or more of the problems described above.

According to apects of the present invention, a multi-coupler, which may be used for splitting and/or combining signals, may be formed by joining (e.g., bonding) first and second (or even more) metallized coaxial resonators together. One or more coupling holes may be formed for providing coupling between the first and second coaxial resonators. A coupling hole may be of any size, shape, and/or depth, depending upon the amount and type of coupling desired. A coupling hole may be, e.g., drilled to extend inward from an external surface of the joined first and second coaxial resonators.

Because the coaxial resonators may be already physically arranged in a fixed manner with respect to each other when a coupling hole is formed, the alignment problems of the prior art may be alleviated. Aspects of the present invention thus provide an inexpensive and flexible approach to manufacturing resonator filters; filters may now be economically manufactured in a low-volume and high-product-mix environment.

According to further aspects of the present invention, the coupling hole(s) may be altered or fine-tuned such that a desired frequency response of the filter is obtained. The actual coupling of the multi-coupler may be monitored in real time while the coupling hole is altered so that the desired coupling may be more easily achieved.

According to still further aspects of the present invention, the multi-coupler may have more than two coaxial resonators. The plurality of coaxial resonators may be physically non-linearly arranged with respect to one another. Such a multi-coupler may have the one or more coupling holes described above, and/or there may be multiple distinct coupling holes coupling adjacent coaxial resonators.

Still further aspects of the present invention are directed to, e.g., using one or more of various geometric shapes (e.g., hexagonal); forming one or more coupling holes in any size, shape, and/or depth using a variety of methods such as drilling, milling, and/or etching; forming multiple coupling holes between two adjacent coaxial resonators; and/or forming a multi-coupler from two, three, four, five, six, seven, or more coaxial resonators.

These and other features of the invention will be apparent upon consideration of the following detailed description of preferred embodiments. Although the invention has been defined using the appended claims, these claims are exemplary in that the invention is intended to include the elements and steps described herein in any combination or subcombination. Accordingly, there are any number of alternative combinations for defining the invention, which incorporate one or more elements from the specification, including the description, claims, and drawings, in various combinations or subcombinations. It will be apparent to those skilled in filter theory and design, in light of the present specification, that alternate combinations of aspects of the invention, either alone or in combination with one or more elements or steps defined herein, may be utilized as modifications or alterations of one or more aspects of the invention. It is intended that the written description of the invention contained herein covers all such modifications and alterations.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 is a perspective view of a conventional filter having a plurality of coaxial resonators.

FIG. 2 is a perspective view of another conventional filter having a monoblock configuration.

FIG. 3 is a side view of a conventional filter having a plurality of coaxial resonators interconnected with a coupling board.

FIG. 4 illustrates an equivalent circuit of the filter shown in FIG. 3.

FIG. 5 is a perspective view of an embodiment of a filter according to aspects of the present invention.

FIG. 6a is a side view of an embodiment of a filter according to aspects of the present invention.

FIG. 6b is a top view of the filter shown in FIG. 6a.

FIG. 7 is a side view of an embodiment of a filter according to aspects of the present invention.

FIG. 8 is a side view of an embodiment of a filter according to aspects of the present invention having quarter-wave resonators.

FIG. 9 is a side view of an embodiment of a filter according to aspects of the present invention having half-wave resonators.

FIG. 10 is a perspective view of an embodiment of a filter according to aspects of the present invention wherein the resonators are coupled via axial coupling holes.

FIG. 11 illustrate the relationship between the location of a coupling hole and the amount and type of coupling in a filter consistent with the embodiment shown in FIG. 6a but using only a single coupling hole.

FIG. 12 illustrates the relationship between the depth of an axial coupling hole from a metallized end and the amount and type of coupling in a filter consistent with the embodiment shown in FIG. 10 but using only a single axial coupling hole.

FIG. 13 illustrates the relationship between the depth of an axial coupling hole from a non-metallized end and the amount and type of coupling in a filter consistent with the embodiment shown in FIG. 10 but using only a single axial coupling hole.

FIG. 14 is a perspective view of an embodiment of a multi-coupler according to aspects of the present invention.

FIG. 15 is an end view of a multi-coupler and/or filter having three resonators.

FIG. 16 is an end view of a multi-coupler and/or filter having five resonators.

FIG. 17 is an end view of a multi-coupler and/or a filter having seven resonators.

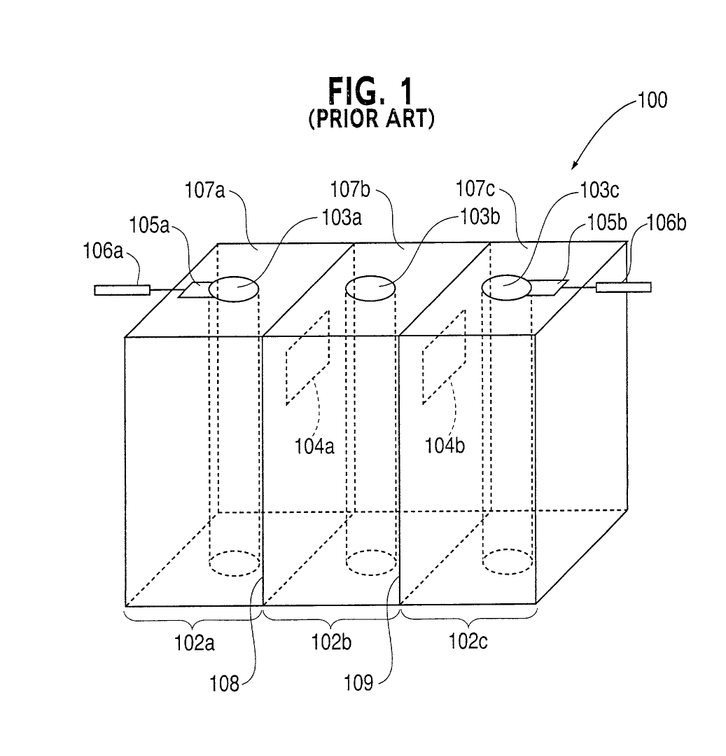

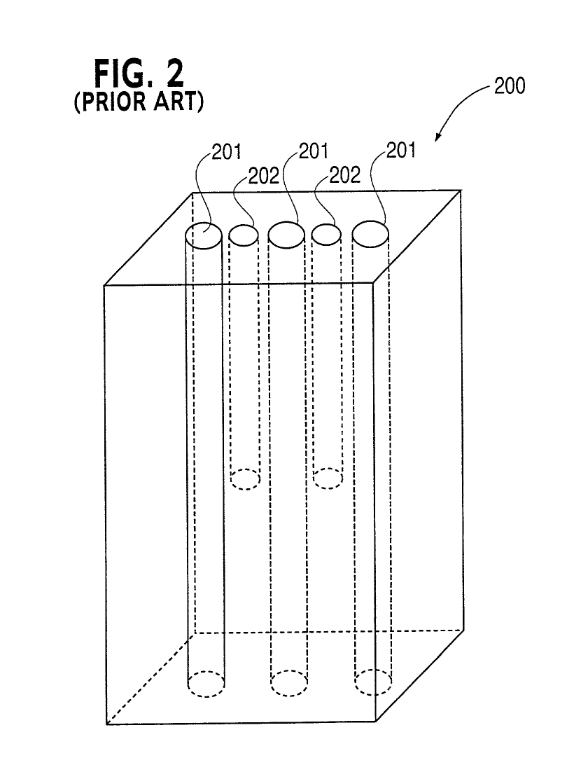

### DETAILED DESCRIPTION OF PREFERRED EMBODIMENTS

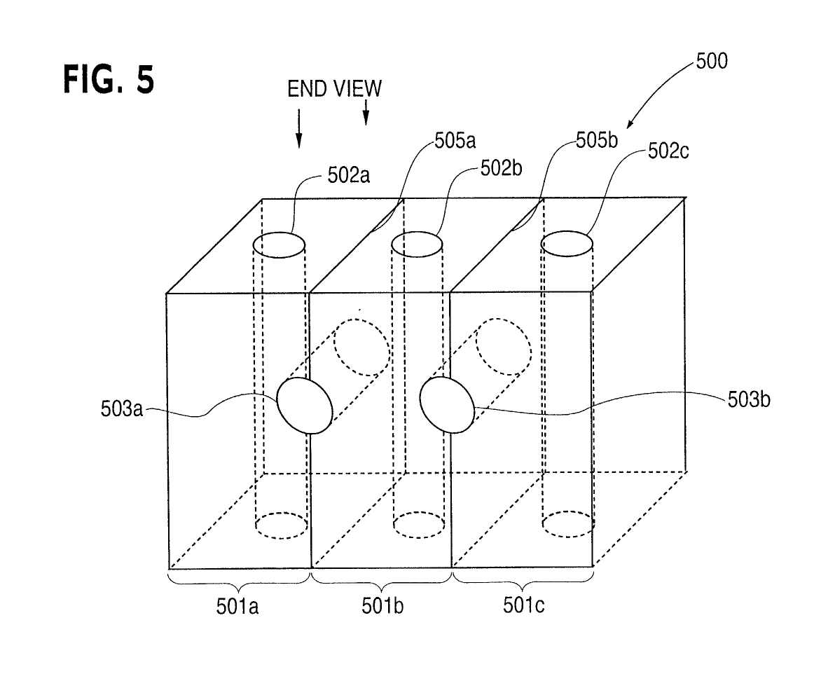

Referring to FIG. 5, a plurality of conventional coaxial resonators 501a, 501b, 501c having resonator holes 502a, 502b, 502c may be bonded together at ground planes 505a, 505b to form a coaxial resonator filter 500. The resonators 501a-c may be bonded together in a variety of ways such as by soldering. The coaxial resonator filter 500 may be configured to have the frequency response of any type of filter such as a bandpass filter.

Resonators may be of various lengths. Where a plurality of resonators are utilized in the coaxial resonator filter 500, each resonator in a filter may be of the same length or of different lengths. For example, the resonators on either end of a series of resonators may be of the same length with one or more internal resonators being of a different length (e.g., either shorter or longer). A very low frequency coaxial resonator may be long, having a length ranging between, for example, 1 to 2.5 inches for frequencies of approximately 100 to 300 MHZ. On the other hand, a very high frequency coaxial resonator may have a length of, for example, 0.25 inches or less for frequencies in the Giga hertz range. Furthermore, each resonator may be used as a quarter-wave, half-wave, and/or full-wave resonator. Further, the resonator may be open at one or both ends (i.e., not metallized or otherwise not conductive at one or more ends). Where a resonator is open at both ends, the resonator may function as a half-wave resonator. Where a resonator is open at one end, it may function as a quarter-wave resonator.

In embodiments of the invention, coupling between adjacent resonators (e.g., 501a and 501b, or 501b and 501c) may be accomplished by forming one or more coupling holes 503a, 503b between the adjacent resonators. The coupling holes 503a-b may be of any size, shape, and/or depth, and may be formed by any manufacturing technique, including drilling, forming, machining, milling, etching, grinding, laser milling, water cannon milling, and/or sandblasting. Drilling provides a simple, inexpensive, and high precise method of forming the resonator holes 503a-b. The coupling holes 503a-b between the resonators 501a-c may be variously configured to be of any shape such as a circle, square, rectangle, triangle, oval, hexagon, pentagon, trapezoid, and/or any other geometric or non-geometric shape. Where a configuration other than round coupling holes is utilized, the coupling holes may be milled into the resonators. Regardless of the technique used, it is important that the Q of the dielectric material (e.g., ceramic) of a resonator is maintained. One way that this may be accomplished is by ensuring that the physical integrity of the resonator material is maintained. Accordingly, it may be preferable to utilize an ultrasonic drill method in order to drill the holes without compromising the Q of the ceramic.

The amount of coupling between coaxial resonators 501a-c may be controlled by adjusting the depth, diameter/size, shape, location, and/or number of coupling holes 503a-b. The larger the diameter and/or depth of a coupling hole, the greater the amount of coupling that will be created between adjacent resonators.

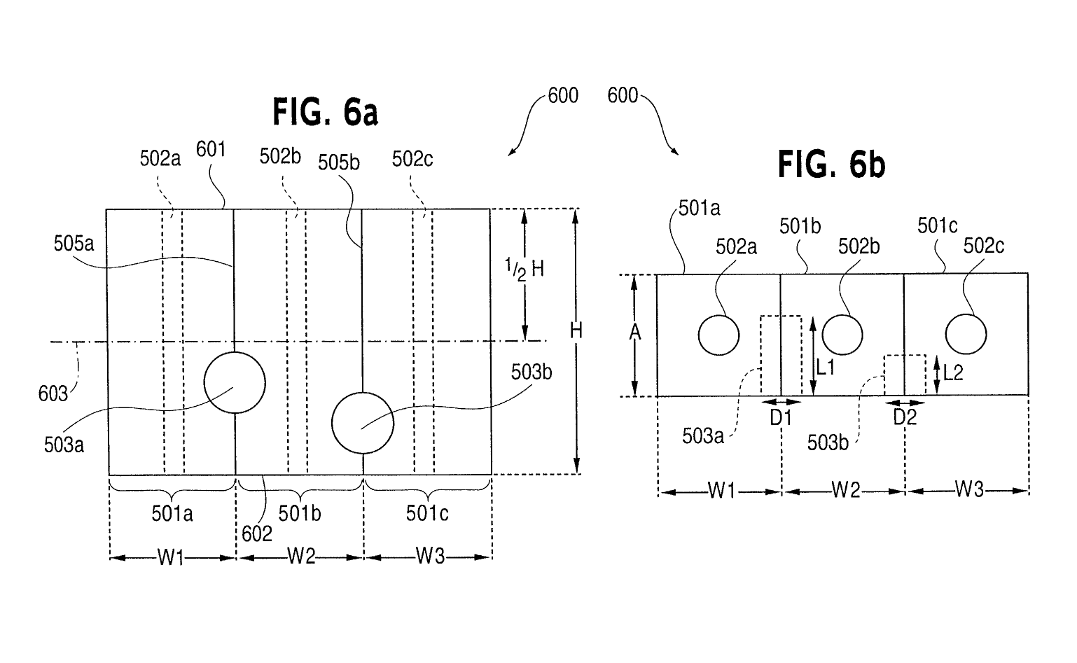

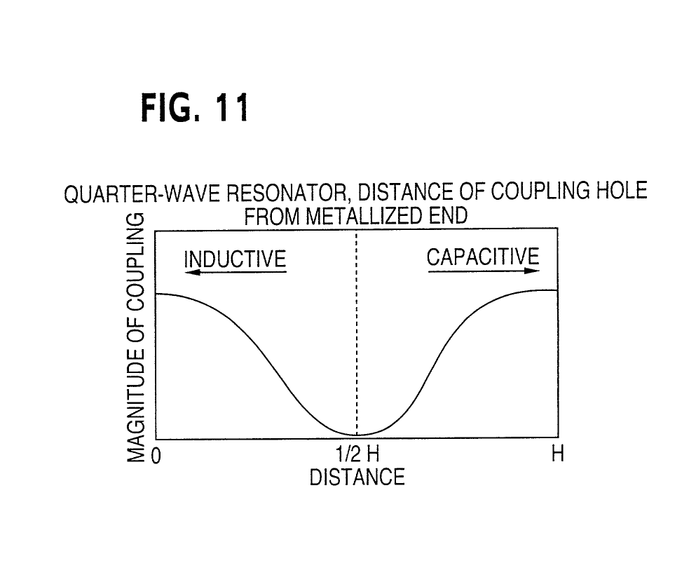

The amount and type of coupling may further vary depending on the location of the hole. For example, as shown in FIG. 6a, assuming that the resonators 501a-b are quarter-wave resonators, as the coupling hole 503a in a filter 600 is further offset from the center axis 603 (defined as the set of points equidistant from the top end 601 and the bottom end 602) towards one of the ends 601 or 602, the amount of coupling between the coaxial resonators 501a and 501b increases. However, as the coupling hole 503a approaches the imaginary central axis 603, the amount of coupling decreases. As the location of coupling hole 503a approaches a metallized end (i.e., conductive or short-circuited end) (e.g., end 601), the type of coupling between resonators 501a and 501b will become more inductive. On the other hand, as the location of coupling hole 503a approaches a non-metallized end (e.g., end 602), then the type of coupling between resonators 501a and 501b will be more capacitive. Furthermore, if the coupling hole 503a is located at the central axis 603, the coupling hole 503a creates both inductive and capacitive coupling that substantially cancel each other out, resulting in little or no coupling between the resonators 501a and 501b. FIG. 11 shows the approximate relationship which may occur between the location of a side coupling hole (such as coupling hole 503a) and the amount and type of coupling provided by the coupling hole. The relationship plotted in FIG. 11 is approximate and may be more curved or less curved than shown depending upon the configuration of the resonators.

The size of a coupling hole further affects the amount of coupling provided. In the embodiment shown in FIGS. 6a and 6b, the holes are circular and have diameters, respectfully, of D1 and D2. As D1 is increased for coupling hole 503a, for example, the coupling between the resonators 501a and 501b increases.

As shown in FIG. 6b, the depth L1, L2 of the coupling holes 503a-b may also be varied, further affecting the amount of coupling. Where a coupling hole is drilled in from one and/or both sides of the resonators, such as are coupling holes 503a-b in FIGS. 6a and 6b, the deeper the coupling hole, the greater the coupling. For example, where a coupling hole passes all the way through the resonators (e.g., where L1 equals A), a maximum amount of coupling may be provided for a given location and size of the coupling hole. However, where a coupling hole is drilled only partially through either one side and/or both sides of the resonator (e.g., where L1 is less than A), the amount of coupling will be less than the coupling provided by the same coupling hole that passes all the way through the resonators.

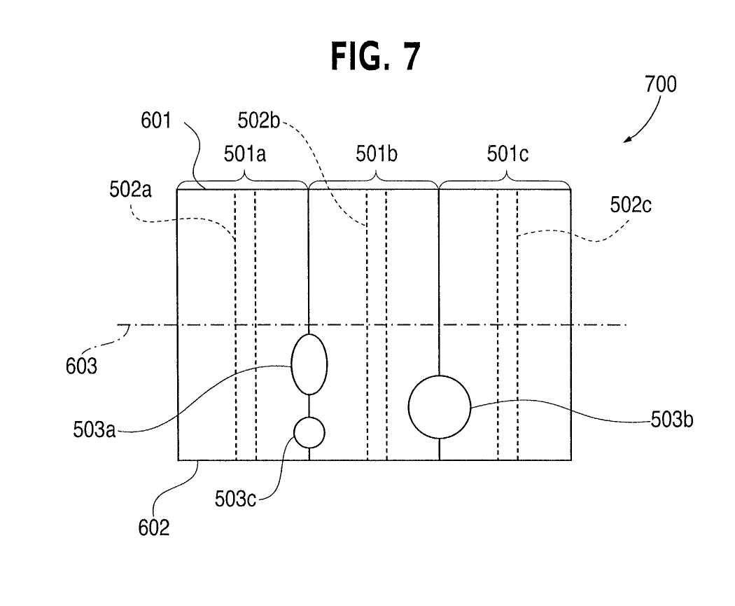

Referring to FIG. 7, where the resonator for a low frequency filter is extremely long, it may be desirable to put two or more coupling holes (e.g., 503a and 503c) between a pair of resonators (e.g., 501a and 501b). However, in a half-wave resonator having multiple such holes, the holes 501a, 501c should not be located on different sides of the central axis 603, since the coupling of each hole may partially or fully cancel the coupling of the other hole. Accordingly, in a half-wave resonator where a plurality of holes are utilized to increase coupling, the coupling holes 501a, 501c are preferably located near or at the same end (i.e., either end 601 or end 602).

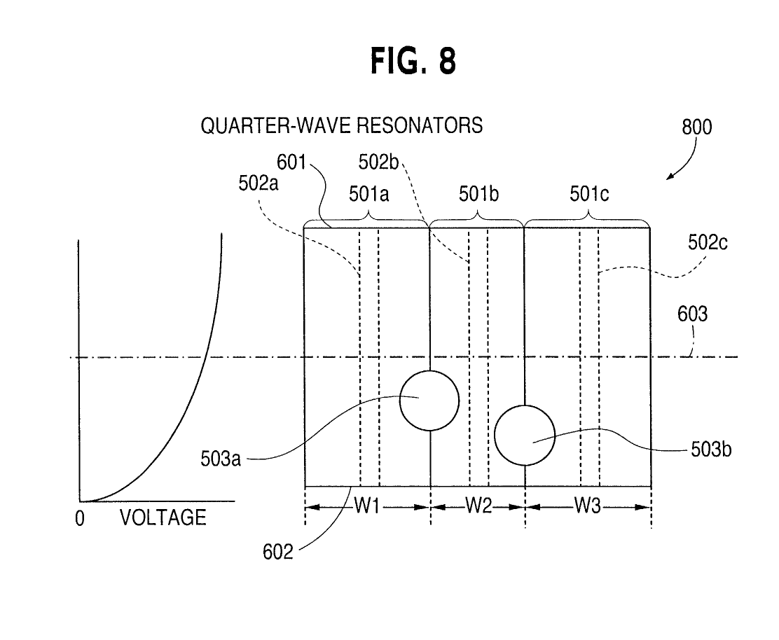

Coupling may further be controlled by adjusting the widths of one or more coaxial resonators. For example, in the exemplary embodiment shown in FIG. 8, the width W2 of the resonator 501b has been reduced as compared with widths of resonators 501a and 501c (W1 and W3, respectively) such that the distances between the resonator hole 502b and the coupling holes 503a, 503b are decreased, thereby increasing the amount of coupling between resonator hole 502b and the coupling holes 503a, 503b.

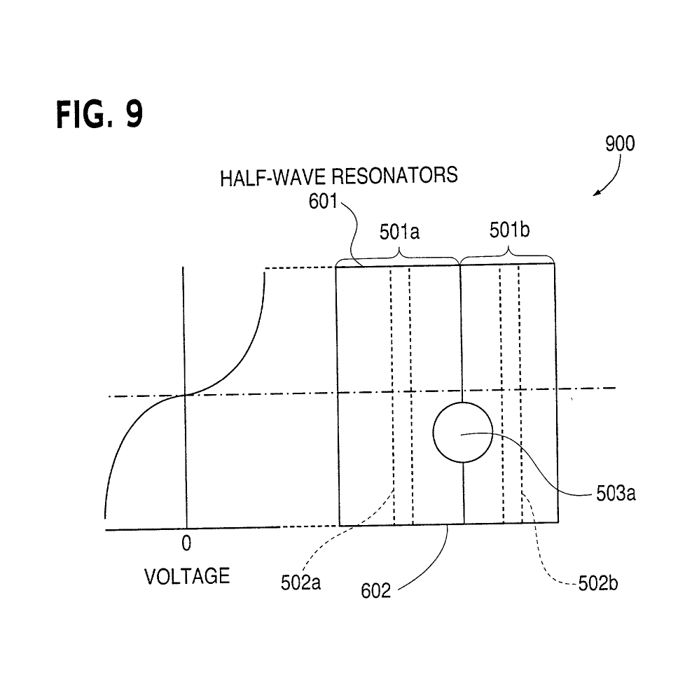

In embodiments of a quarter-wave resonator such as those shown in FIG. 8, the voltage at the metallized end will be approximately zero. In such a resonator, the voltage along the length of the resonator may be a quarter wave. However, in embodiments of a half-wave resonator such as those shown in FIG. 9, both ends of a resonator may be open (i.e., both ends 601 and 602 may not be metallized). In such half-wave resonator embodiments, an imaginary ground plane 603 is disposed midway between each open end 601, 602 of the resonators 501a-b of a filter 900. The imaginary ground plane 603 defines the point at which the voltage is zero along the length of the resonators. In such embodiments, coupling hole 503a may be located on either side of the imaginary ground plane 603, depending on whether capacitive and/or inductive coupling is desired. To achieve capacitive coupling, the coupling hole 503a should be drilled near to an end 601, 602 of the resonator. To achieve inductive coupling, the coupling hole 503a should be drilled nearer to the imaginary ground plane 603. For maximum coupling, such as may be required in a wide bandwidth filter, the coupling hole 503a should be large and should be located closer to the imaginary ground plane 603 than to the ends 601, 602. Alternatively, for a small bandwidth filter, the coupling hole 503a should be located at or near an end 601, 602. By using a half-wave resonator, twice the center frequency may be achieved as compared with a quarter-wave resonator of the same length. Thus, under the present invention, a half-wave resonator may be used to double the frequency band for which a filter is usable.

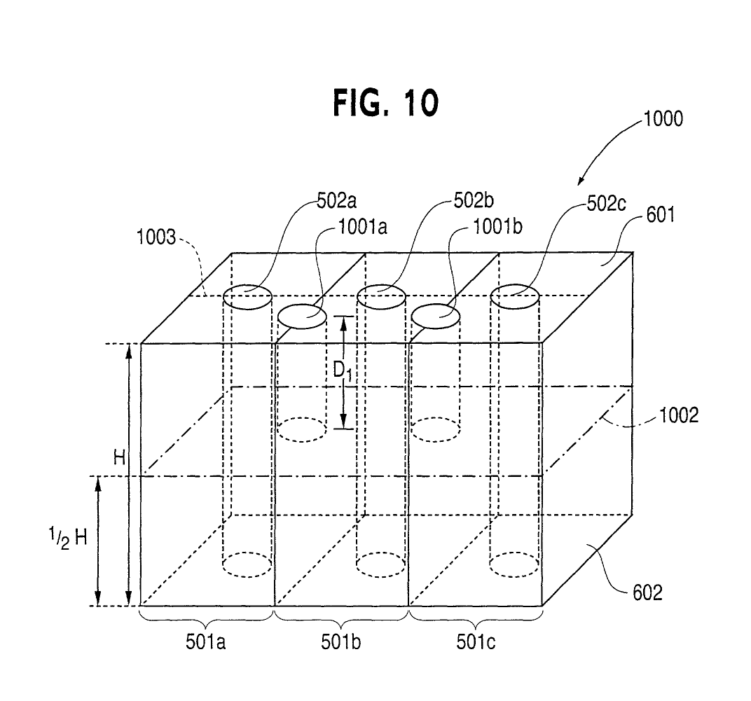

Referring to FIG. 10, coupling holes 1001a, 1001b may be formed in an axial direction on one or more ends of the resonators. These axial coupling holes may be utilized in addition to or as an alternative to the radial coupling holes discussed above. In some coaxial resonator filters, a combination of axial and/or radial holes may be utilized. The depth and location of such axial coupling holes 1001a-b may determine the amount of coupling and/or the type of coupling (i.e., capacitive and/or inductive). For example, if the resonators 501a-b are quarter-wave resonators (e.g., one of the ends 601, 602 is metallized), then as the depth D1 of the axial coupling hole 1001a increases from zero up to the imaginary mid-plane 1002 that defines the midpoint between the two ends 601, 602, the amount of coupling provided by the axial coupling hole 1001a increases. If the end 601 is the metallized end, then the axial coupling hole 1001a would provide inductive coupling between the resonators 501a-b. If the end 601 is the non-metallized end, then capacitive coupling would instead be provided. However, once the depth D1 of the axial coupling hole 1001a increases beyond the imaginary mid-plane 1002, then the total amount of coupling may begin to decrease. Thus, in these embodiments, to provide the maximum amount of coupling, the depth D1 should equal half of the length H of the resonators 501a-b. One reason that the coupling may decrease once D1 is greater than one-half of H is that both inductive and capacitive coupling may be provided that partially or fully cancel each other.

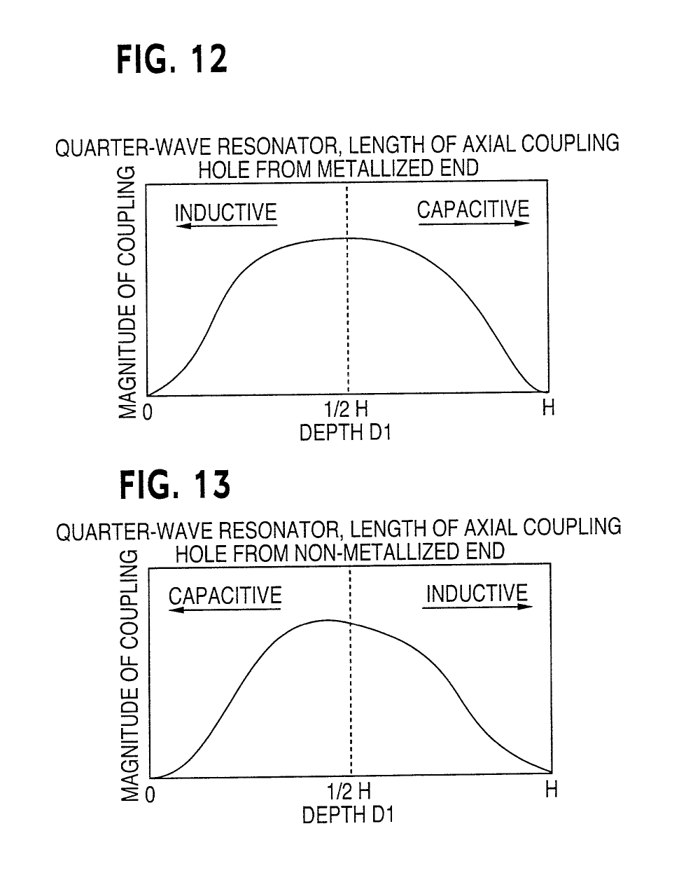

Also, the closer an axial coupling hole (e.g., axial coupling hole 502a) is to the imaginary middle axis 1003, the greater the coupling provided by the coupling hole. FIGS. 12 and 13 illustrate the approximate relationship which may occur between the depth of an axial coupling hole 1001a and the relative magnitude and type of coupling provided by the axial coupling hole. The relationships plotted in FIGS. 12 and 13 are approximate and may be more curved or less curved than shown depending upon the configuration of the resonators.

Coupling holes are thus the coupling vehicles between coaxial resonators, and so the exact field configuration between the coaxial resonators and the desired filter properties dictates the location, depth, shape, and/or size of the hole. For example, in a quarter-wave resonator for a narrow-band filter (e.g., less than 1%, defined as the percentage ratio of the bandwidth measured between the two −3 dB points, divided by the center frequency of the filter), it may be desirable to have relatively little coupling and thus to locate the coupling hole (e.g., coupling hole 503a) towards the central axis 603 between the metallized and non-metallized ends (e.g., ends 602 and 601, respectively) of the resonators. On the other hand, a large bandwidth filter (e.g., 10%) typically requires a relatively large amount of coupling. In such a filter, the coupling hole 503a may be located at or near an end of the resonator (e.g., at or near the metallized end), and for maximum coupling should be located on a major surface between adjacent resonators, as shown in FIGS. 5, 6a, and 6b. The coupling hole 503a in such a filter should also be as large as possible, for instance having a diameter D1 of up to slightly less than one-half of the width W1 of the coaxial resonator 501a for a large bandwidth filter. A resonator filter according to aspects of the present invention may achieve up to and beyond 6% bandwidth, which is approximately twice the bandwidth achievable using conventional resonator filters.

Table 1 lists the measured frequency characteristics of various exemplary filter embodiments according to the present invention. In these listed filters, a single coupling hole was drilled between two adjacent quarter-wave resonators with the bottom end metallized. Thus, in the column in Table 1 labeled, “Hole Location,” “top” refers to the coupling hole being located near the non-metallized end, and “bottom” refers to the coupling hole being located near the metallized end. The resonators in these particular embodiments are each approximately 8 millimeters in length.

TABLE 1

| Hole | | Center | | | |
|---|---|---|---|---|---|
| Diameter | Hole | Frequency | Bandwidth | Insertion | |
| (inches) | Location | (MHZ) | (MHZ) | Loss (dB) | Loading |
| 0.035 | top | 1,173.0 | 7.9 | −3.48 | 0.32 R |
| | bottom | 1,154.1 | 22.7 | −1.33 | 0.55 K |
| 0.0465 | top | 1,173.1 | 8.96 | −3.39 | 0.32 R |
| | bottom | 1,151.0 | 27.2 | −1.13 | 0.62 D |
| 0.0635 | top | 1,173.5 | 11.7 | −2.68 | 0.38 K |
| | bottom | 1,145.4 | 33.1 | −0.88 | 0.70 D |
| 0.082 | top | 1,177.7 | 13.7 | −1.99 | 0.42 R |
| | bottom | 1,142.6 | 38.8 | −0.86 | 0.76 K |
| 0.0938 | top | 1,180.1 | 14.4 | −1.7 | 0.44 D |
| | bottom | 1,136.6 | 41.7 | −0.74 | 0.82 D |

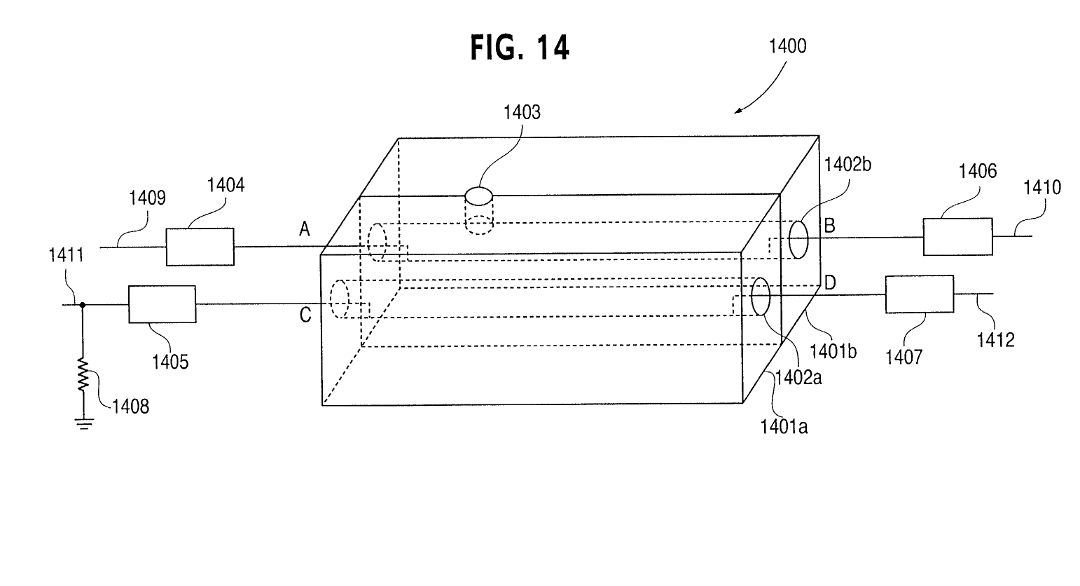

Referring to FIG. 14, in some embodiments of the invention, two or more resonators 1401a, 1401b may be bonded together to form a multi-coupler 1400. The resonators 1401a,b may be coupled together via one or more coupling holes 1403 (the coupling holes may be radial and/or axial coupling holes, and the multi-coupler 1400 may include one, two, three, four, five, or more holes) The multi-coupler 1400 may have several ports (e.g., ports A, B, C, and D) connected to transmission lines 1409-1412 via matching networks 1404-7 (which may include, e.g., transformers, resistors such as resistor 1408, and/or other impedance matching systems). The ports A, B, C, D may be defined by connections to the resonator holes 1402a-b at or near the ends of the resonator holes 1402a-b, for example as shown in FIG. 14. Alternatively, the ports may be defined by any type of conductive physical extension of the conducting layer within the resonator holes 1402a-b.

Signal A may be fed into, for example, port A via transmission line 1409. In such an embodiment, signal B may be produced at port B, and signal D may be produced at port D. In effect, the multi-coupler may split signal A into signals B and D, wherein signals B and D may be similar to signal A except for their energies. The relative energies of signals A, B, and D may depend upon the amount of coupling between the two resonators 1401a-b. The amount of coupling may depend upon the configuration of the coupling hole 1403 in the same way as for any of the other embodiments described herein. In one typical embodiment, signals B and D may each be approximately 3 dB less than signal A. In such an embodiment, the energy of signal A would be split equally among signals B and D. However, the multi-coupler 1400 may be configured to provide any amount of coupling between the two resonators 1401a-b. For example, depending upon the configuration of the multi-coupler 1400, signal D may be in the range of 1 to 3 dB, 3 to 10 dB, or even 10 to 40 dB less than signal A.

The multi-coupler 1400 may further be used to combine two or more input signals. For example, two input signals B and D may be provided via transmission lines 1410, 1412 to ports B and D of the multi-coupler 1400. Responsive to receiving signals B and D, the multi-coupler 1400 may provide a combined output signal A on port A. In such a configuration, signal A would include a combination of coupled signals B and D, coupled via the coupling hole 1403.

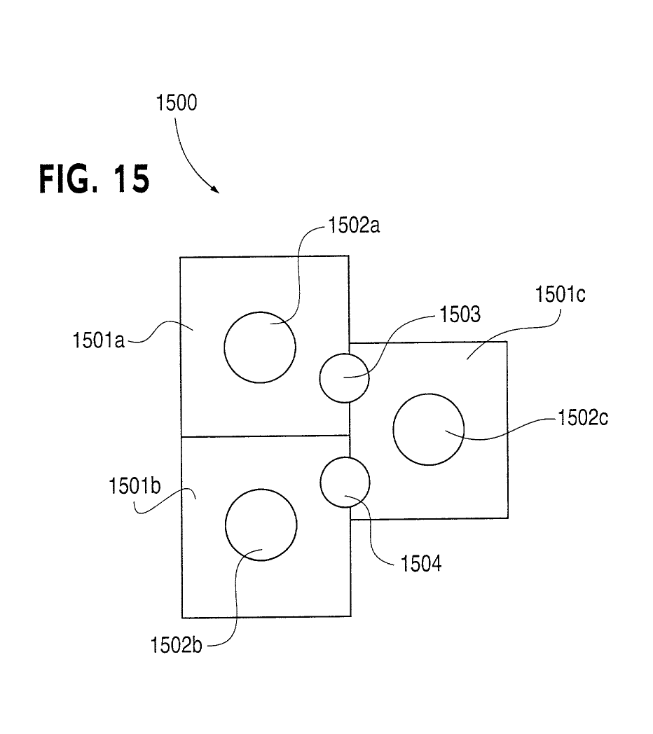

Any number of resonators (e.g., two, three, four, five, six, or seven resonators) may be bonded together in any combination in the manner described herein for use as a multi-coupler and/or as a filter. For instance, the filter 500 may be used as a multi-coupler in a similar manner as described above for multi-coupler 1400. In such an embodiment, an input signal (analogous to signal A described above) may be fed into resonator hole 502b and two output signals (each analogous to signal D) may be produced by resonator holes 502a and 502c. In an alternative embodiment as shown in FIG. 15, three resonators 1501a, 1501b, 1501c having resonator holes 1502a, 1502b, 1502c, respectively, may be physically non-linearly arranged with respect to one another, as opposed to the resonators 501a-c shown in FIG. 5, which are physically linearly arranged with respect to one another. In such an embodiment, the resonators 1501a-c may be bonded together as shown in FIG. 15 to be used as a multi-coupler and/or filter 1500. FIG. 15 shows the resonators from a point of view analogous to the view labeled “end view” in FIG. 5. After bonding the resonators 1501a-c together, axial and/or side coupling holes (e.g., axial coupling holes 1503, 1504) may be formed at one or more bonding sites between the resonators.

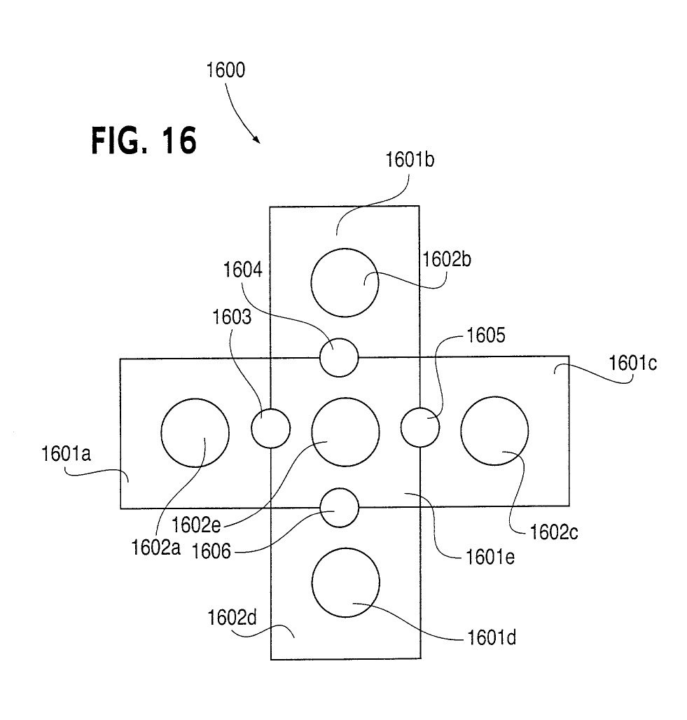

In a further embodiment such as is shown in FIG. 16, five resonators 1601a, 1601b, 1601c, 1601d, 1601e having resonator holes 1602a, 1602b, 1602c, 1602d, 1602e, respectively, may be joined (e.g., bonded) together to be used as a multi-coupler and/or filter 1600. After bonding the resonators 1601a-e together, axial and/or side coupling holes (e.g., axial coupling holes 1603, 1604, 1605, 1606) may be formed at one or more bonding sites between the resonators. In still further embodiments, a plurality of resonators may be bonded together in any pattern such as a square or hexagonal matrix. Some of all of the coupling holes 1603, 1604, 1605, 1606 may be formed prior to a complete joining of all of the coaxial resonators. For example, once resonators 1601a and 1601e are joined together, coupling hole 1603 may be formed prior to joining the other coaxial resonators 1601b, 1601c, 1601d.

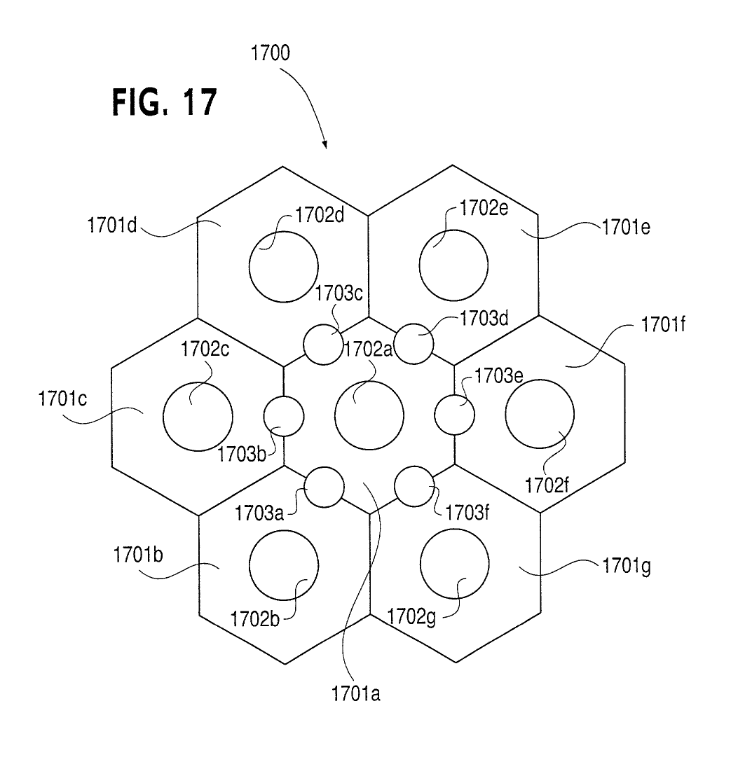

A resonator does not necessarily need to have a rectangular/square outer shape (as are, e.g., the resonators 501a-c shown in FIG. 6b) when viewed from an end but may be of any shape such as a circle, oval, triangle, hexagon, pentagon, trapezoid, and/or any other geometric or non-geometric shape. Indeed, a shape other than a rectangle or square may allow a plurality of resonators to physically fit among each other more easily than a rectangular shape would allow, and such a shape may even provide improved coupling between such resonators. For example, a matrix of resonators 1701a, 1701b, 1701c, 1701d, 1701e, 1701f, 1701g are shown in the multi-coupler 1700 of FIG. 17. The multi-coupler 1700 may also be used as a filter. The resonators 1701 have resonator holes 1702a, 1702b, 1702c, 1702d, 1702e, 1702f. Various resonators 1701 within the multi-coupler 1700 may be coupled together via coupling holes such as coupling holes 1703a, 1703b, 1703c, 1703d, 1703e, 1703f. Of course, the coupling holes 1703 may be located as necessary, and not just as shown in the exemplary embodiment of FIG. 17. For example, a coupling hole may be located at the junction between resonators 1701d and 1701e.

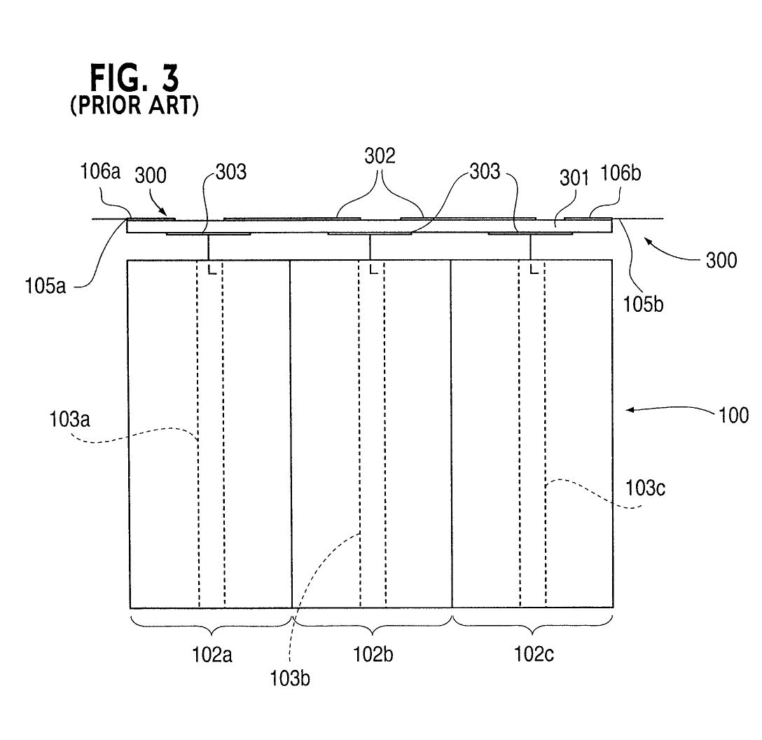

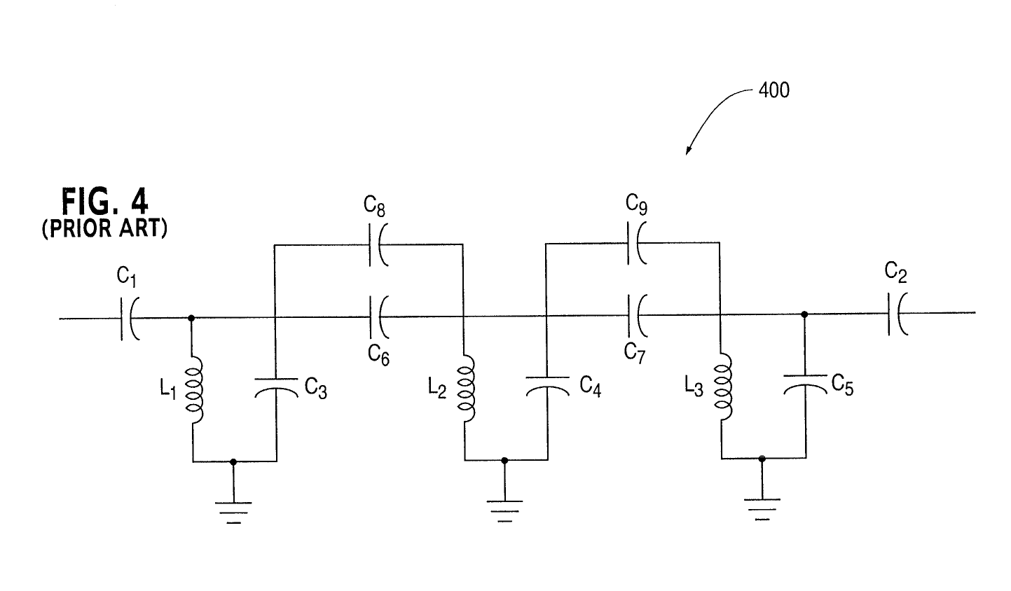

Once a filter and/or a multi-coupler has been assembled and coupling holes have been formed, additional small holes may be drilled to adjust or fine-tune the frequency response and/or coupling of the filter and/or multi-coupler. For example, if a coupling hole that provides inductive coupling were drilled too deep, the coupling may be corrected by drilling a small additional axial or other coupling hole on or near a non-metallized end. In this way, capacitive coupling may be increased, partially canceling-out the inductive coupling provided by the incorrectly-drilled coupling hole. In addition or alternatively, existing coupling holes may be precision-drilled in order to fine-tune the filter. Currently, milling technology allows for coupling holes to be formed at an accuracy of within approximately 1/35,000 of an inch in depth and 1/50,000 of an inch in diameter. Fine-tuning by adjusting and/or adding coupling holes obviates the need for a coupling board such as the coupling board 300 for the conventional resonator filter shown in FIG. 3. Further, the coupling holes may be automatically fine-tuned by coupling a spectrum analyzer to the output and signal generator to the input such that the filter may be automatically and/or fine tuned by, for example, a CNC milling machine responsive to the signal output from the spectrum analyzer.

Thus, in the present invention, the coupling holes in a filter and/or a multi-coupler may be formed after the resonators are coupled together. In some embodiments of the present invention, manufacturing tolerances and performance are much improved at substantially lower manufacturing costs as compared with conventional techniques. One reason for this is that the alignment difficulties that arise from individually machining separate windows in each resonator prior to assembly of the filter may be avoided, providing a much more easily and inexpensively-manufactured filter and/or multi-coupler. Additionally, once coupling holes are formed, the coupling holes may be milled to achieve a precise electrical configuration (e.g., adjustment of depth and/or diameter). Furthermore, the coupling and/or frequency characteristics of the filter may be measured in real-time as the coupling holes are drilled, allowing the use of a computer capable of monitoring such measurements to automatically control the drilling and/or machining. The manufacturing process may be completely automated, even when precisely-tuned filters are required and/or when high-mix/low-volume operations are implemented.

While exemplary systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments.

We claim:

1. A method for forming a multi-coupler comprising the steps of:
joining first and second coaxial resonators together; and
then forming a first coupling hole for providing coupling between the first and second coaxial resonators.

2. The method of claim 1, wherein the step of forming includes forming the first coupling hole to extend inwardly from an external surface of the joined first and second coaxial resonators.

3. The method of claim 2, wherein the step of forming includes forming the first coupling hole such that the first coupling hole is disposed in both the first and second coaxial resonators.

4. The method of claim 1, wherein the step of joining includes bonding the first and second coaxial resonators together.

5. The method of claim 1, wherein the step of forming includes forming the first coupling hole having physical dimensions and a location on the external surface according to a desired type and amount of coupling between the first and second coaxial resonators.

6. The method of claim 1, further including the step of forming a second coupling hole distinct from the first coupling hole, for providing coupling between the first and second coaxial resonators.

7. The method of claim 1, further including the step of altering a physical configuration of the coupling hole according to a predetermined coupling of the multi-coupler, such that an actual coupling of the multi-coupler is altered.

8. The method of claim 7, wherein the step of altering includes altering at least one of a depth and a width of the first coupling hole.

9. The method of claim 7, further including the step of monitoring the actual coupling of the multi-coupler in real time during the step of altering.

10. The method of claim 1, wherein the step of joining includes joining the first and second coaxial resonators together, the first coaxial resonator being a half-wave resonator.

11. The method of claim 1, wherein the step of forming includes drilling the first coupling hole.

12. The method of claim 1, wherein the step of forming includes ultrasonically drilling the first coupling hole.

13. The method of claim 1, further including the step of joining a third coaxial resonator to the second coaxial resonator and to the first coaxial resonator such that the first, second, and third resonators are physically non-linearly arranged with respect to one another.

14. A multi-coupler for splitting an input signal into a first output signal and a second output signal, the multi-coupler comprising:
a first coaxial resonator for receiving the input signal; and
a second coaxial resonator joined with the first coaxial resonator, the multi-coupler having a first coupling hole extending inward from an external surface of the joined first and second coaxial resonators for providing coupling between the first and second coaxial resonators, the first and second output signals being thereby generated by the first and second coaxial resonators, respectively.

15. The multi-coupler of claim 14, further including an input port connected to the first coaxial resonator for carrying the input signal to the first coaxial resonator, a first output port connected to the second coaxial resonator for carrying the first output signal from the first coaxial resonator, and a second output port connected to the first coaxial resonator for carrying the second output signal from the second coaxial resonator.

16. The multi-coupler of claim 15, wherein the first and second coaxial resonators each have a resonator hole, the input port and the first output port being connected to the resonator hole of the first coaxial resonator, the second output port being connected to the resonator hole of the second coaxial resonator.

17. The multi-coupler of claim 14, wherein the first and second coaxial resonators are bonded together.

18. The multi-coupler of claim 14, wherein the first coupling hole is substantially circular.

19. The multi-coupler of claim 14, wherein the first coaxial resonator further includes a resonator hole, the first coupling hole being an axial coupling hole extending substantially parallel to the resonator hole.

20. The multi-coupler of claim 14, wherein the first coaxial resonator further includes a resonator hole, the first coupling hole extending substantially orthogonally relative to the resonator hole.

21. A multi-coupler for combining a first input signal and a second input signal into an output signal, the multi-coupler comprising:
a first coaxial resonator for receiving the first input signal; and
a second coaxial resonator joined with the first coaxial resonator for receiving the second input signal, the multi-coupler having a first coupling hole extending inward from an external surface of the joined first and second coaxial resonators for providing coupling between the first and second coaxial resonators, the output signal being thereby generated from the first coaxial resonator.

22. The multi-coupler of claim 21, further including a first input port connected to the first coaxial resonator for carrying the first input signal to the first coaxial resonator, a second input port connected to the second coaxial resonator for carrying the second input signal to the second coaxial resonator, and an output port connected to the first coaxial resonator for carrying the output signal from the first coaxial resonator.

23. The multi-coupler of claim 22, wherein the first and second coaxial resonators each have a resonator hole, the first input port and the output port being connected to the resonator hole of the first coaxial resonator, the second input port being connected to the resonator hole of the second coaxial resonator.

24. The multi-coupler of claim 21, wherein the first and second coaxial resonators are bonded together.

25. The multi-coupler of claim 21, wherein the first coupling hole is substantially circular.

26. The multi-coupler of claim 21, wherein the first coaxial resonator further includes a resonator hole, the first coupling hole being an axial coupling hole extending substantially parallel to the resonator hole.

27. The multi-coupler of claim 21, wherein the first coaxial resonator further includes a resonator hole, the first coupling hole extending substantially orthogonally relative to the resonator hole.

28. A method for altering a coupling of a multi-coupler having a first coaxial resonator joined with a second coaxial resonator, the method comprising the steps of:
forming a coupling hole for providing coupling between the first and second resonators; and
altering the coupling of the multi-coupler by altering a physical configuration of the coupling hole.

29. The method of claim 28, wherein the step of altering includes monitoring the coupling in real time during the step of altering.

30. The method of claim 28, wherein the step of altering includes altering at least one of a depth and a width of the coupling hole.
